(19) United States
(12) Patent Application Publication
(10) Pub. No.: US 2006/0049217 A1
(43) Pub. Date: Mar. 9, 2006

(54) Tool for hydro cleaner machine suitable for cleaning of surfaces

(75) Inventor: Felice Vassanelli, Cavaion Veronese (IT)

Correspondence Address: BROWDY AND NEIMARK, P.L.L.C.;624 NINTH STREET, NW, SUITE 300, WASHINGTON, DC, 20001-5303, US

(73) Assignee: S.I.S.T.E.M.A. S.R.L., Villafranca Di Verona (IT)

(21) Appl. No.: 11/178,507

(22) Filed: Jul. 12, 2005

(30) Foreign Application Priority Data
Sep. 3, 2004 (IT) RE2004A000104

(51) Int. Cl. B65D 47/00

(52) U.S. Cl. 222/559; 137/528; 222/251

(57) ABSTRACT

A tool (1) for a hydro cleaner machine adapted for the washing of surfaces by means of high speed water jets, comprising: a conveyor conduit (5) for high pressure water; a container tank (7) for a detergent, having an mouth for filling, and an mouth (71) for the discharge; and a distributor device (8) which, associated with said discharge mouth (71) of said container tank (7) is adapted to distribute the detergent on the surfaces to be washed.

The present finding refers to a tool for a hydro cleaner machine suitable, in particular, for the cleaning of surfaces.

As is known, a tool of this type generally comprises a sleeve through which it is connected to the usual lances of the hydro cleaner machines, a high-pressure conduit, and a rotating device adapted to generate high-speed water jets.

During the operating action, the hydro cleaner machine generates a pressurised water flow that passes through the lance and it is sent inside the tool where, passing along the high-pressure conduit it reaches the rotating device.

Usually said rotating device presents a distributor element that directs said water flow towards a plurality of hollow arms mounted to rotate thereon, each of which is provided on its extremity with a suitable nozzle, through which the pressurised water exits in the form of high-speed jets.

In particular, said nozzles are addressed in a sloping direction in relation to the surface to be washed, in such a manner that the water jets lap said surface, and at the same time, benefiting from the principle of reaction, also rotatably engage the hollow arms.

One problem linked with this type of tools for hydro cleaner machines lies in the fact that, in cases where the surfaces to be washed need to be sprinkled with detergents, this operation must be performed before the hydro cleaner machine is used, generally using other suitable instruments.

This fact involves a larger amount of manual work for the washing operator, greater time loss, and in the end, also greater cost.

The object of the present finding is to overcome the aforesaid problem with a solution that is simple, rational and at reasonable cost.

This object is achieved by means of a tool for hydro cleaner machines adapted for washing surfaces by means of high-speed water jets, comprising: a high pressure water conveyor conduit; a tank to contain detergent, having a mouth for filling, and a mouth for discharging; and a distribution device which, when associated with said discharge mouth of the container tank, is adapted to distribute the detergent.

Thanks to this solution, the detergent distribution operation on the surfaces to be washed occurs simultaneously with the washing stage, thus saving a considerable amount of time; moreover, said operation is performed without the need for instruments other than the hydro cleaner machine tool.

According to a preferred embodiment of the finding, the distribution device comprises a downflow conduit for the detergent adapted to place in communication the container tank with the exterior, and a closure system adapted to be activated in order to open or close said downflow conduit, permitting or preventing the exit of the detergent.

Preferably, said closure system is associated with the pressurised water conveyor conduit in order to be activated by the pressure itself of the water.

Thanks to this solution, the finding provides automatic detergent distribution, which occurs simultaneously with the generation of the high-speed jets when the tool is crossed by a pressurised water flow.

According to a further preferred embodiment of the finding, the tool comprises a system to regulate the amount of detergent that can exit towards the exterior, and whose operation is independent from the distribution device, and which is controlled directly by the operator. In this manner it is possible to choose whether to use the detergent or not, and in the case where detergent is to be used, it is possible to regulate the amount of detergent as required, thus advantageously preventing waste.

The dependent claims describe preferred and particularly advantageous embodiments of the tool for washing surfaces according to the finding.

Further characteristics and advantages of the finding will be made clear from the following description provided by way of a non-limiting example, with the help of the illustrated figures in the appended tables wherein:

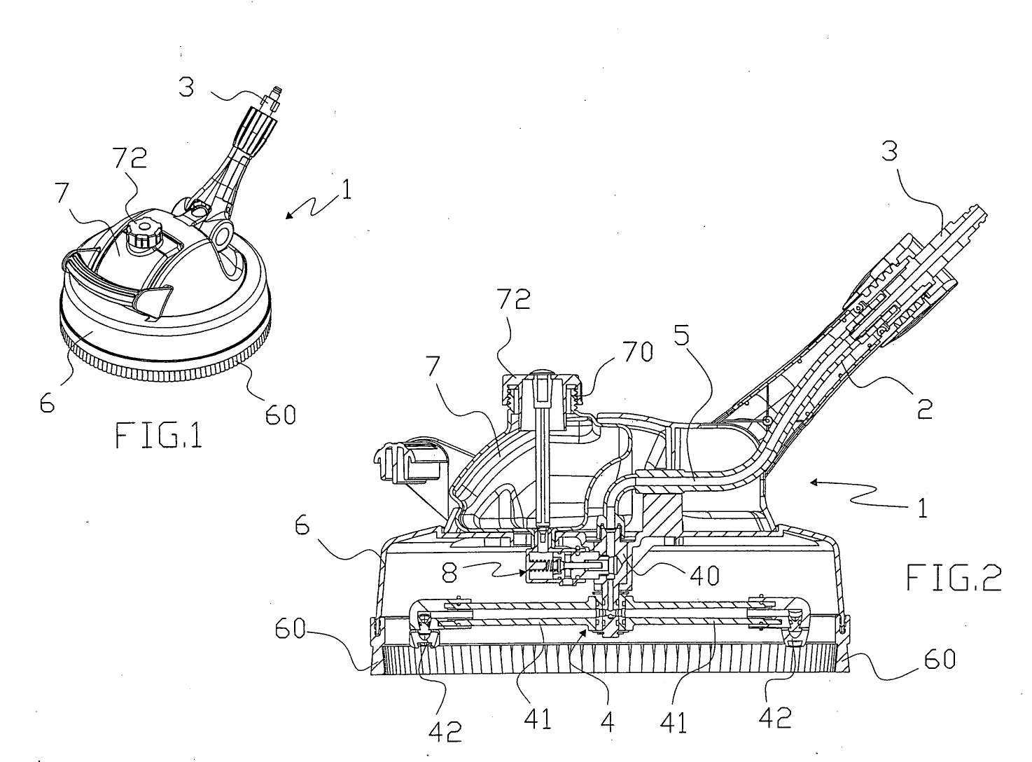

FIG. 1 shows a tool for a hydro cleaner machine according to the invention, in a perspective view;

FIG. 2 is a section view of the tool according to FIG. 1;

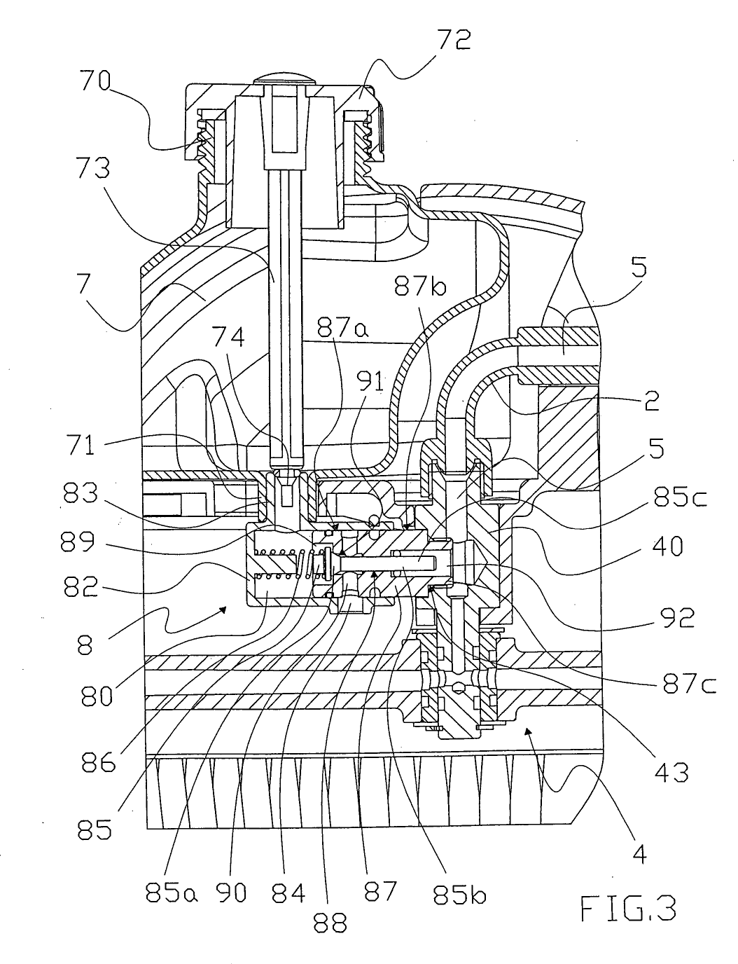

FIG. 3 is a detail of FIG. 1 according to a first embodiment of the finding;

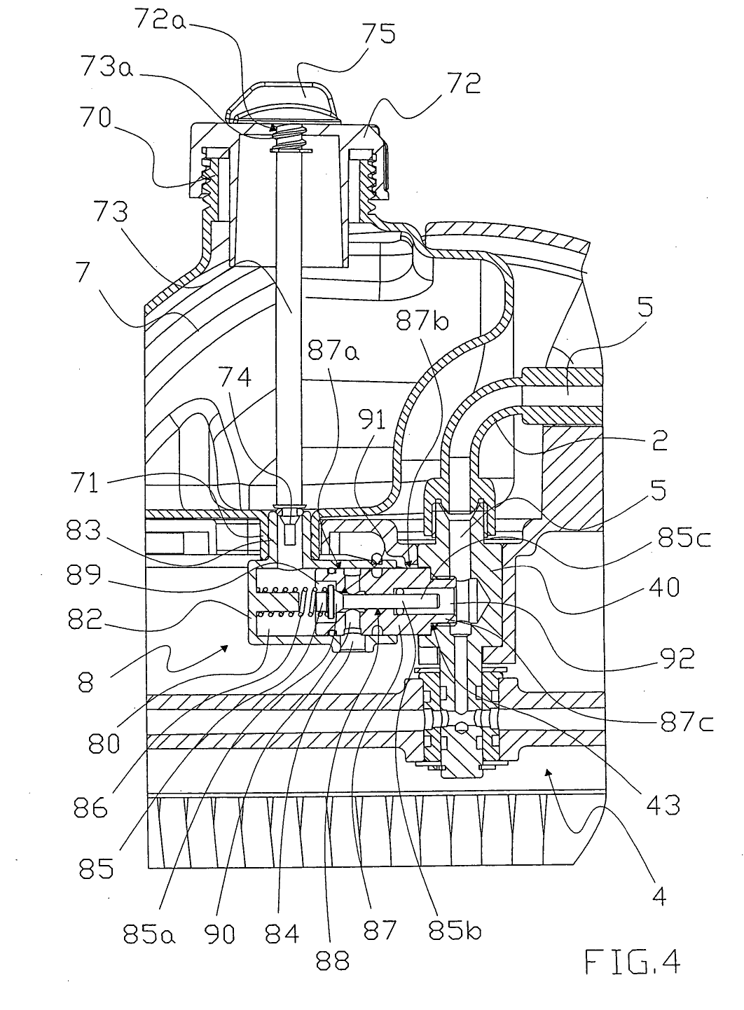

FIG. 4 is the detail of FIG. 3 according to a second embodiment of the finding;

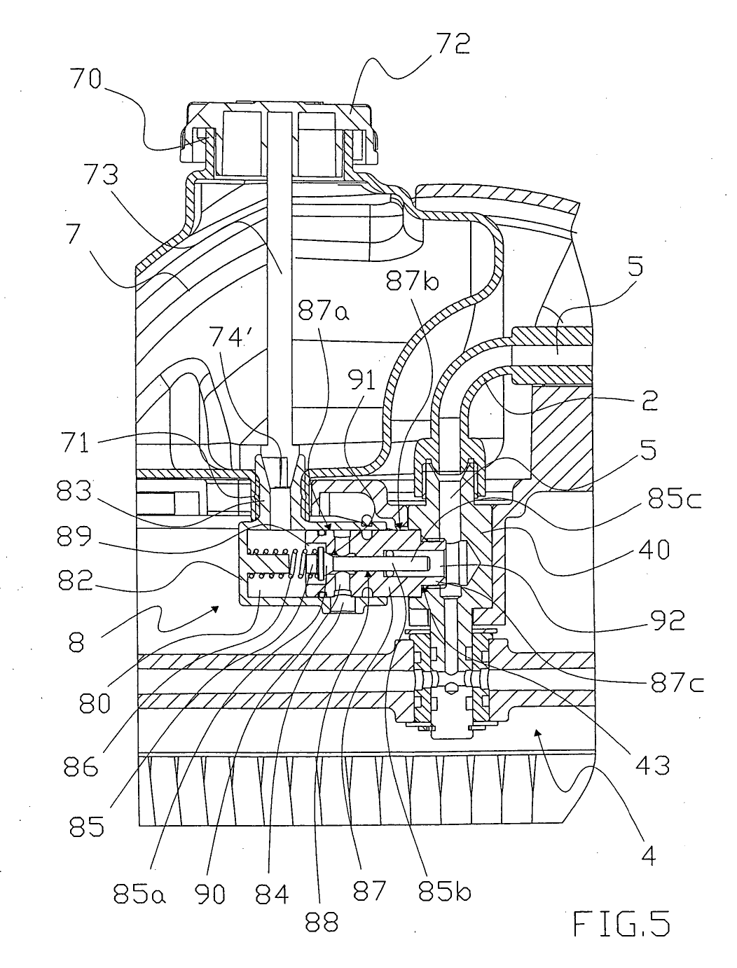

FIG. 5 is the detail of FIG. 3 according to a third embodiment of the finding;

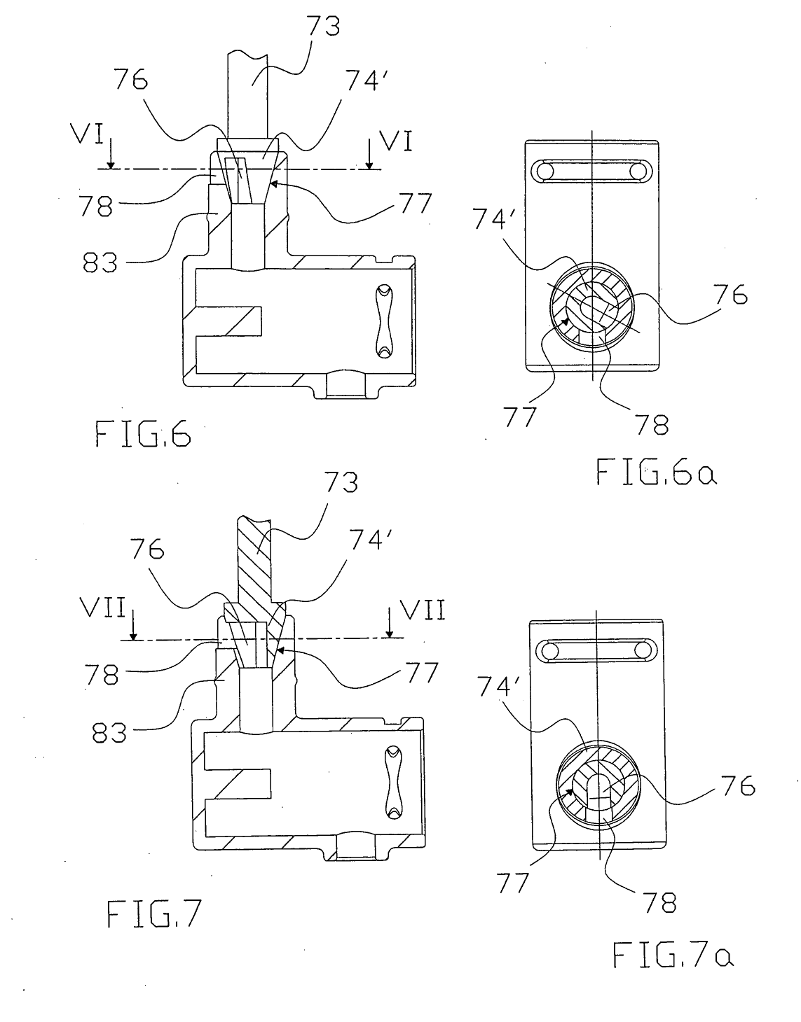

FIG. 6 is the detail of FIG. 5 shown in the configuration that prevents detergent distribution, and where certain elements have been eliminated to highlight the details of the finding;

FIG. 6a is the section VI-VI of FIG. 6;

FIG. 7 is the detail of FIG. 5 shown in the configuration that permits detergent distribution, and where certain elements have been eliminated to highlight the details of the finding;

FIG. 7a is the section VII-VII of FIG. 7;

The aforesaid figures show a tool 1 for a hydro cleaner machine, which is used for washing surfaces.

Said tool 1 comprises a high pressure conduit 2, having a first end associated with a sleeve 3 for connection to a common lance for hydro cleaner machines, and a second end associated with a rotating device 4 adapted to generate high speed water jets (see FIG. 2); said high pressure conduit 2, sleeve 3, and rotating device 4 being adapted to define, within their interior, a conveyor conduit 5 for pressurised water produced by the pump of the hydro cleaner machine.

The rotating device 4 is supported and protected by an external convex shell 6, wherein the concave side is facing in a downward direction and is open at the bottom, and whose bottom edge is associated with a brush rim 60 adapted to make contact with the surfaces to be washed. Said rotating device 4 is composed of a rigid distributor element 40, fixed to the external shell 6 and fed from the high pressure conduit 2, that directs the pressurised water inside two hollow arms 41, integral to each other and mounted to rotate at one end of the distributor element 40 itself (see FIGS. 2, 3, 4); said arms 41 are equipped with nozzles 42 adapted to generate high speed water jets, which, being directed in a manner that coincides with the sloping direction in relation to the surface to be cleaned, rotatably engage the arms 41 themselves (see FIG. 2).

Above the external shell 6, is mounted a container tank 7 for liquid detergent, having a filler mouth 70, and a discharge mouth 71, positioned respectively at the top and at the bottom of the tank 7 itself.

Associated with the discharge mouth 71 and positioned under the container tank 7, the tool 1 comprises a distributor device 8 for the liquid detergent, which in turn comprises a downflow conduit 80 adapted to connect tank 7 with the exterior, and a closure system for said downflow conduit 80 (see FIG. 2); the closure system being adapted to being activated in order to open or close the conduit 80, to permit or prevent the exit of the detergent.

In the detail (see FIGS. 3 and 4) the downflow conduit 80 is defined by an external cup-shaped envelope 82 equipped at its side surface with two openings, an inlet 83, and an outlet opening 84 respectively, wherein the first opening 83 protrudes and is inserted for a determined distance inside the discharge mouth 71 of the container tank 7, while the second opening 84 is open to the exterior.

The closure system comprises (see FIGS. 3 and 4): a valve 85 which slides axially, equipped with an obturator 85a, and a rod 85b; a spring 86 adapted to counter the axial motion of the valve 85; and a valve body 87 which, together with the interposition of a sealing means, is partially inserted inside the external envelope 82 in order to present a first portion 87a that intercepts the downflow conduit 80, and a second protruding portion 87b, that associates with the distributor element 40 of the rotating device 4.

In particular, said association between the second portion 87b and the distributor element 40 is obtained by connecting means that comprises: an attachment seat 43, obtained in the distributor element 40, adapted to connect the conveyor conduit 5 with the exterior, and a corresponding insertion section 87c of the valve body 87 adapted to couple with said seat 43 (see FIGS. 3 and 4).

Inside the valve body 87, at the first portion 87a, are two tubes 89 and 90 connected to each other through a port 91, adapted to define a passage for the detergent from the entry opening 83 towards the exit opening 84; while at the second portion 87b is a casing 92 that presents an end in communication with the conveyor conduit 5, and which is connected to conduit 90 through a guide seat 88 inside which slides the rod 85b of valve 85, together with a seal.

In this manner, as can be seen in FIGS. 3 and 4, said valve 85 results as being arranged inside the valve body 87 so that the obturator 85a is positioned in the downflow conduit 80 and acts on the port 91, and the rod 86b presents a section of end 86c that extends inside the conveyor conduit 5, contained inside the casing 92.

It should be noted that, in spite of the fact that the valve body 87, shown in the figures, is a body separated from the external envelope 82 of the distributor device 8, it could be possible to foresee its construction in a single body with said external envelope 82, without departing from the context of the described solution. During use, when the command organs of the hydro cleaner machine do not permit the passage of the pressurised water through the lance, the spring 86, acting directly on the obturator 85a, presses it onto the edge of the port 91, thus closing the passage and preventing the exit of any detergent towards the exterior.

On the other hand, when said command organs are activated, the conveyor conduit 5 is crossed with high-pressure water, which penetrates the casing 92 of the valve body 87, and surrounds the end section 85c of the valve 85 contained inside it.

The water pressure generates on said end section 85c a force that provokes the axial movement of the valve 85, and therefore of obturator 85a, in contrast with the action of the spring 86; said movement provoking the opening of the port 91, thus permitting the exit of the detergent contained in the downflow conduit 80, through the outlet opening 84.

Moreover, the construction of tool 1 permits to regulate the amount of detergent that exits when the hydro cleaner machine is in operation.

In fact, as can be seen in FIGS. 2, 3, and 4, the filler mouth 70 of the container tank 7 is vertically aligned with the discharge mouth 71, and is threaded externally to permit the screwing/unscrewing of a closure cap 72, also threaded; said closure cap 72 is associated with a first end of a vertical rod 73, whose second end is equipped with a penetrating body 74 adapted to axially insert inside said discharge mouth 71, and in the particular case shown in the figures, inside the inlet opening 83 of the distributor device 8.

In this manner, according to the relative position assumed by the penetrating body 74 compared to the opening 83, the size of the passage section of the opening varies, and therefore the amount of detergent that can cross through to reach the down flow conduit 80, will also vary.

In particular, the penetrating body 74 is adapted to be moved axially in order to move progressively from a position that closes the opening 83 completely (see FIGS. 3 and 4), to a position that leaves it completely open, and is moved by activating means.

According to a first embodiment of the finding, shown in FIG. 3, said activation means are composed of the closure cap 72 itself, which is integrally associated to the rod 73.

In fact, in this manner when said cap 72 is completely screwed onto the filler mouth, the penetrating body 74 is set in a position so that it closes the opening 83; later, by manually unscrewing the cap 72 itself, the rod 73 and penetrating body 74 are progressively moved axially in an upward direction, thus opening the passage. On the other hand, according to a second embodiment of the finding, shown in FIG. 4, said regulating means comprise a threaded section 73a on the rod 73, adapted to engage into a corresponding threaded hole 72a realised in cap 72, and a knob 75 associated with the section 73a itself and arranged externally on the container tank 7.

In this case, in order to regulate the detergent flow, the knob 75 is manually turned to screw or unscrew the threaded section 73a in the threaded hole 72a: when completely screwed the penetrating body 74 closes the opening 83, then by unscrewing it progressively, the rod 73 and the penetrating body 74 are moved axially in an upward direction thus opening the passage.

Lastly a third embodiment of the finding shown in FIGS. 5, 6, and 7 foresees the closure cap 72 associated with the filler mouth 70 by means of a bayonet connection, and the vertical rod 73, having a first end associated rigidly with said closure cap 72, is mounted with an obturator body 74′ in a frusto-conical shape on the other end, inside which is a casing 76.

When the closure cap 72 is united with the filler mouth 70, said obturator body 74′ is engaged inside a connected seat 77, associated with the discharge mouth 71 and equipped with a recess 78. In the particular case illustrated in FIGS. 5, 6, and 7, said connected seat 77 is obtained in the end section of the inlet opening 83 of the distributor device 8; said end section extending inside the container tank 7 and presenting the aforesaid recess 78.

In this manner, when the casing 76 is at least partially facing the recess 78, this defines a passage that permits the detergent to reach the downflow conduit 80 (see FIGS. 7, 7a), whereas in the opposite case, the container tank 7 is completely closed (see FIGS. 6, 6a).

Since the bayonet connection permits, for a determined angle, the rotation of the closure cap 72 without disengaging it from the mouth 70, according to this third embodiment of the finding, the amount of detergent is regulated by rotating said closure cap 72 in a manner so that in a corresponding manner, the obturator body rotates in a relative manner in the connected seat 77 from a position where the casing 76 faces the recess 78 completely, to a position wherein no passage is defined, or vice versa.

1. Tool (1) for a hydro cleaner machine adapted for washing surfaces by means of water jets, comprising a conveyor conduit (5) for high pressure water, characterised in that it comprises:
a container tank (7) for a detergent having a filler mouth (70) and a discharge mouth (71), and
a distributor device (8) which, associated with said discharge mouth (71) of the container tank (7) is adapted to distribute the detergent on the surfaces to be washed.

2. Tool (1) for a hydro cleaner machine according to claim 1, characterised in that said distribution device (8) comprises an external envelope (82) that defines a downflow conduit (80) adapted to connect the container tank (7) with the exterior, and a closure system (85, 86, 87) of said downflow conduit (80) adapted to be activated to permit or prevent the exit of the detergent.

3. Tool (1) for a hydro cleaner machine according to claim 2, characterised in that said distribution device (8) is associated with the conveyor conduit (5) for the high pressure water, in a manner so that the closure system (85, 86, 87) is activated by the pressure itself of the water.

4. Tool (1) for a hydro cleaner machine according to claim 2, characterised in that said closure system comprises a sliding valve (85) and elastic means (86) adapted to counter the movement of said valve (85); said valve (85) being equipped with a rod (85b) and an obturator (85a) which, positioned inside the downflow conduit (80) is adapted to permit or prevent the exit of the detergent.

5. Tool (1) for a hydro cleaner machine according to claim 4, characterised in that said elastic counter means comprise a spring (86).

6. Tool (1) for a hydro cleaner machine according to claim 4, characterised in that the rod (85b) of said valve (85) presents at least one end section (85c) that extends inside the conveyor conduit (5).

7. Tool (1) for a hydro cleaner machine according to claim 4, characterised in that said closure system comprises a valve body (87) inside which is defined a guide seat (88) for the rod (85b) of the valve (85).

8. Tool (1) for a hydro cleaner machine according to claim 7, characterised in that said valve body (87) is fixed to the conveyor conduit (5) by connecting means (43, 87c) in turn associated with said valve bodies (87) and with the conveyor conduit (5).

9. Tool (1) for a hydro cleaner machine according to claim 8, characterised in that said connecting means comprise an attachment seat (43) obtained in a wall of the conveyor conduit (5) and adapted to connect the conveyor conduit (5) itself with the exterior; and an insertion section (87c) of the valve body (87), adapted to couple with said seat (43) so that at least one end section (85c) of the rod (85b) of the valve (85) extends inside said conveyor conduit (5).

10. Tool (1) for a hydro cleaner machine according to claim 9, characterised in that at least one part of the conveyor conduit (5) is defined by a rigid distributor element (40), and said attachment seat (43) is obtained in said distributor element (40).

11. Tool (1) for a hydro cleaner machine according to claim 9, characterised in that said valve body (87) is partially inserted inside the external envelope (82) of the downflow conduit (80) so that it presents a first portion (87a) that intercepts the downflow conduit (80) itself, and a second protruding portion (87b) at which is obtained said insertion section (87c).

12. Tool (1) for a hydro cleaner machine according to claim 11, characterised in that inside the valve body (87), at the first portion (87a) are two tubes (89, 90) adapted to define a passage for the detergent towards the exterior, and which are connected through a port (91) on which acts the obturator (85a) of the valve (85) permitting or preventing the exit of the detergent.

13. Tool (1) for a hydro cleaner machine according to claim 12, characterised in that inside the valve body (87) at the second portion (87b) is a casing (92) which communicates with the conveyor conduit (5), inside which is contained the end section (85c) of the valve (85).

14. Tool (1) for a hydro cleaner machine according to claim 7, characterised in that said valve body (87) is a single body with the external element (82) of the downflow conduit (80).

15. Tool (1) for a hydro cleaner machine according to claim 1, characterised in that it comprises a regulating system (72, 73, 74, 74′, 75, 77) for the amount of detergent that can be distributed.

16. Tool (1) for a hydro cleaner machine according to claim 15, characterised in that said regulating system comprises a penetrating element (74) adapted to be inserted axially inside the discharge mouth (71) of the container tank (7) thus reducing the passage section in a corresponding manner.

17. Tool (1) for a hydro cleaner machine according to claim 16, characterised in that said regulating system comprises a rod (73), one end of which is associated with said penetrating body (74) and activating means (72, 72a, 73a, 75) adapted to provoke the axial movement of the penetrating body (74) itself.

18. Tool (1) for a hydro cleaner machine according to claim 17, characterised in that said activating means comprise a threaded section (73a) of the rod (73) adapted to engage into a corresponding threaded hole (72a) of the container tank (7), and a knob (75), associated with the rod (73) and arranged on the exterior of the tank (7), adapted to be manually rotated to provoke the screwing/unscrewing of the threaded section (73a) relative to the threaded hole (72a) and thus, the axial movement of the rod (73) and the penetrating body (74).

19. Tool (1) for a hydro cleaner machine according to claim 18, characterised in that the discharge mouth (71) is vertically aligned with the filler mouth (70), which is equipped with a closure cap (72) which contains said threaded hole (72a).

20. Tool (1) for a hydro cleaner machine according to claim 17, characterised in that the discharge mouth (71) is vertically aligned with the filler mouth (70), which is externally threaded, and said activating means comprises a closure cap (72) also threaded and adapted to engage on the filler mouth (70) to which the rod (73) is integrally associated.

21. Tool (1) for a hydro cleaner machine according to claim 15, characterised in that said regulating system comprises:
an obturator body (74′) adapted to engage with a corresponding connected seat (77) associated with the discharge mouth (71) of the container tank (7) in a manner so that said discharge mouth (71) is closed to the passage of the detergent; said obturator body (74′) and connected seat (77) presenting respectively a casing (76) and a recess (78) conformed in a manner so that for a determined angled position, the obturator body (74′) results in a position facing the connected seat (77) thus defining a passage for the detergent towards the exterior;
a rod (73) one end of which is associated with said obturator body (74′) and
activating means adapted to provoke the axial rotation of the obturator body (74′) itself.

22. Tool (1) for a hydro cleaner machine according to claim 21, characterised in that said discharge mouth (71) is vertically aligned with the filler mouth (70), and said activating means comprise a closure cap (72) adapted to be engaged on the filler mouth (70) by means of a bayonet system, integrally associated to the rod (73).
